(19) United States
(12) Patent Application Publication
(10) Pub. No.: US 2008/0117104 A1
(43) Pub. Date: May 22, 2008

(54) Satellite tracking method

(76) Inventors: Tsui-Tsai Lin, Hsinchu (TW); Da-Ben Fung, Sanyi (TW); Gau-Joe Lin, Longtan (TW); Chien-Hsing Liao, Longtan (TW); Chih-Wen Huang, Sinyuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/601,803

(22) Filed: Nov. 20, 2006

(51) Int. Cl. G05D 1/12; H04B 7/185

(52) U.S. Cl. 342/357.15; 701/3

(57) ABSTRACT

A satellite tracking method is provided. The satellite tracking method first groups satellites into at least two groups on the basis of their arithmetic relationships, then determines whether any satellite of one selected satellite group is within the vision range of a receiving end with the use of a low dimension correlation device, and if that is the case synchronizes the satellite with the receiving end with the use of a full dimension correlation device.

### BACKGROUND OF THE INVENTION

1. Field of the Invention

The present invention relates to a satellite tracking method, and more particularly, to a satellite tracking method with steps of grouping satellites on the basis of their arithmetic relationships, determining whether any given satellite is within the vision range of a low dimension correlation device, and then synchronizing the satellite with the use of full dimension correlation device, which is a good fit in a global satellite positioning system.

2. Description of the Prior Art

The present global satellite positioning system evenly distributes twenty-four satellites on six orbits, meaning each of those orbits has four satellites on it, in order to provide at least four satellites to users on the earth at any given point of time.

Generally speaking, satellites communicate with others by pseudo random code-based (PRC) signals. PRC signal is in the form of a string of binary impulse signals with the characteristic of a noise signal. The global satellite positioning satellite modulates PRC signal with two carrier wave frequencies of 1575.42 and 1227.60 MHz.

PRC signals could be in the form of either coarse/acquisition (C/A) code or precise (P) code. C/A code is of the frequency of 1.023 MHz with the modulation frequency of 1575.42 MHz for the civilian use. On the other hand, P code is primarily for military use and of the frequency of 10.23 MHz with modulation frequencies of either 1575.42 MHz or 1227.60 MHz. With higher frequency, P code is not that vulnerable to interferences, is better for the positioning purpose, but subject to military regulations.

At the time of positioning through the global satellite positioning system, comparison between spread spectrum codes of the received signals of the satellite and original spread spectrum codes is necessary. The length of the spread spectrum code is 1023 bits with the frequency of 1.023. MHz. Every satellite in the global satellite positioning system has its own designated spread spectrum code in order to distinguish from other satellites in the same system.

The receiving end must first recognize the corresponding spread spectrum code from any given positioning satellite and thereafter generates the same spread spectrum code in order to accomplish the synchronization task. The time differential between these two spread spectrum codes is the basis of calculating the distance between the positioning satellite and the receiving end. However, the Doppler shift resulting from the relative speed between the positioning satellite and the receiving end due to the change to relative positions thereof causes the frequency offset, attenuating the efficiency at the time of synchronizing. To get around this, the satellite has to take much more time in simultaneously comparing both the spread spectrum code and the frequency during the synchronization.

With 1023-bit length of the spread spectrum code for each of twenty-four satellites in the positioning system, the receiving end must generate the same 1023-bit long spread spectrum code and compare the self-generated spread spectrum code with 24 other possible sources. In doing so, much more hardware and time for such comparing is required, failing to meet the need for the receiving end.

### SUMMARY OF THE INVENTION

It is therefore a primary objective of the present invention to effectively cut down the probability of satellite data loss and receiving data from wrong satellites so as to accomplish the synchronization task in a relatively quicker manner by first grouping positioning satellites on the basis of their arithmetic relationships, then determining whether the satellite is within the vision range of the receiving end, and then synchronizing the receiving end and the satellite if the satellite is within the vision range of the receiving end.

In accordance with the claimed invention, the present satellite tracking method includes steps of separating a plurality of satellites on a plurality of orbits into a first satellite group and a second satellite group, selecting the first satellite group on the orbit, synchronizing satellites of the first satellite group at the time the first satellite group is within the vision range of a receiving end, selecting the second satellite group while the first satellite group is beyond the vision range of the receiving end, and synchronizing satellites of the second satellite group while the second satellite group on the orbit is within the vision range of the receiving end. To determine whether the satellite is within the vision range of the receiving end, a low dimension correlation device is employed. The receiving end generates a normalized correlation value with the use of the low dimension correlation device and compares the normalized correlation value with a threshold value in the low dimension correlation device. A full dimension correlation device is employed to synchronize the satellite and the receiving end so long as the normalized value is larger than the threshold value. Otherwise, the satellite is not within the vision range of the receiving end and then the present invention method selects satellites on the next nearby orbit to attempt to finish the comparison/synchronization task.

The present invention method also includes steps of selecting satellites on an orbit, determining whether the satellite is within the vision range of a receiving end with the use of a low dimension correlation device, and synchronizing the satellite through a full dimension correlation device if the satellite is within the vision range of the low dimension correlation device. While satellites on any given orbit are not within the vision range of the receiving end, the present invention method selects satellites on the nearby orbit to compare spread spectrum codes of those satellites and the receiving end.

It is an advantage of the present invention that with first determining whether the satellite is within the vision range of the receiving end by the use of the low dimension correlation device the probability of satellite data loss and not receiving data from the satellite as desired could be cut down and the synchronization between the receiving end and the satellite could be accomplished in a relatively quick manner.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a flow chart for the first preferred embodiment according to the present invention.

FIG. 2 is a schematic diagram showing the satellite constellation in according to the present invention.

FIG. 3 is a schematic diagram showing a flow chart for the second preferred embodiment according to the present invention.

FIG. 4 is a schematic diagram showing the flow chart of the operation of the low dimension correlation device according to the present invention.

FIG. 5A is a schematic diagram showing the relationship between the normalized correlation value and chip-rate sample according to the present invention.

FIG. 5B is another schematic diagram showing the relationship between the normalized correlation value and chip-rate sample according to the present invention.

FIG. 6A is a schematic diagram showing the relationship between the threshold value and the probability of satellite data loss/miss according to the present invention.

FIG. 6B is a schematic diagram showing the relationship between the threshold value and probability of false alarm of receiving data from unwanted satellites according to the present invention.

FIG. 7A is a schematic diagram showing the relationship between SNR and the probability of satellite data loss according to the present invention.

FIG. 7B is a schematic diagram showing the relationship between SNR and the probability of false alarm of receiving data from unwanted satellites.

### DETAILED DESCRIPTION OF THE PREFERRED EMBODIMENT

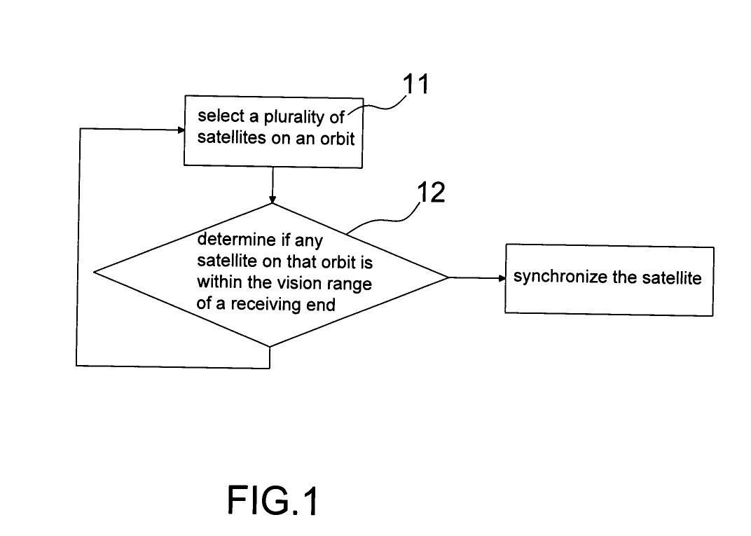

Please refer to FIG. 1 of a flow chart of the first embodiment according to the present invention. The present satellite tracking method includes a satellite selection method including steps as follows:

Step 11: select a plurality of satellites on an orbit; and

Step 12: determine if any satellite on that orbit is within the vision range of a receiving end with the use of a low dimension correlation device and synchronize the satellite and the receiving end with the use of a full dimension correlation device when the former is within the vision range of the latter.

While all satellites on that orbit are not within the vision range of the receiving end other satellites on the next nearby orbit would be selected and aforementioned steps would be repeated as another attempt to accomplish the synchronization task until all satellites have been synchronized with the receiving end. For the purpose of accelerating the synchronization task, the present invention satellite tracking method further separates satellites into at least two groups on the basis of their arithmetic relationships. For example, the present method separates satellites on the same orbit into the first and second satellite groups. When first satellite group is within the vision range of the receiving end the synchronization could begin without determining whether the second satellite group is within the same vision range of the receiving end or not, saving more time than the first preferred embodiment in accordance with the present invention.

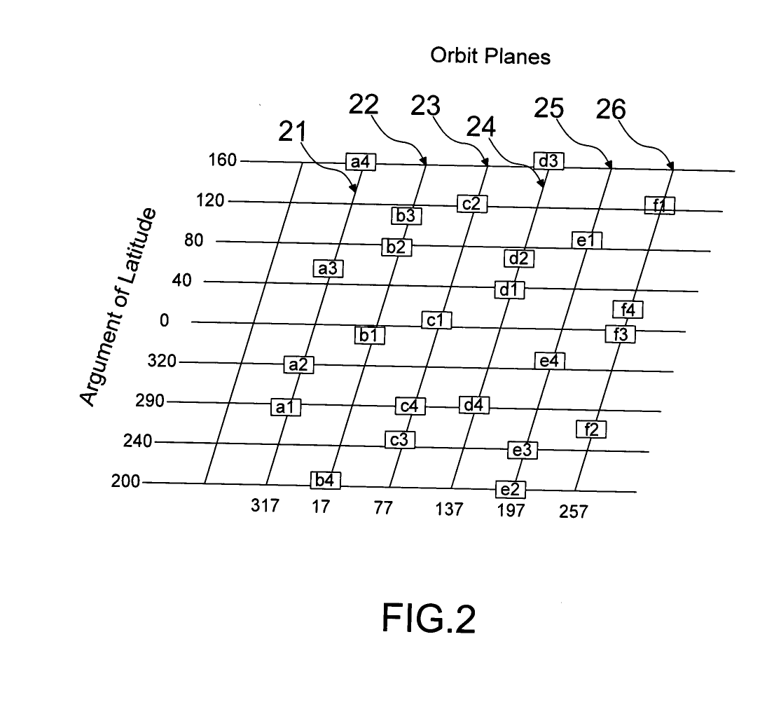

Please refer to FIG. 2 of a schematic diagram showing a satellite constellation according to the present invention. In a 24-satellite global satellite positioning system where these satellites are evenly distributed on six obits, the present invention method separates satellites on any given obit into two satellite groups. The first satellite group includes a plurality of big-angle satellites while the second satellite group is formed with a plurality of nearby satellites. As shown in FIG. 2, the system includes a first orbit 21, a second orbit 22, a third orbit 23, a fourth orbit 24, a fifth orbit 25, and a sixth orbit 26. Four satellites on the first orbit 21 are a1, a2, a3, and a4 where big-angle satellites a1 and a4 are grouped as the first satellite group and nearby satellites a2 and a3 on the same first orbit 21 are of the second satellite group.

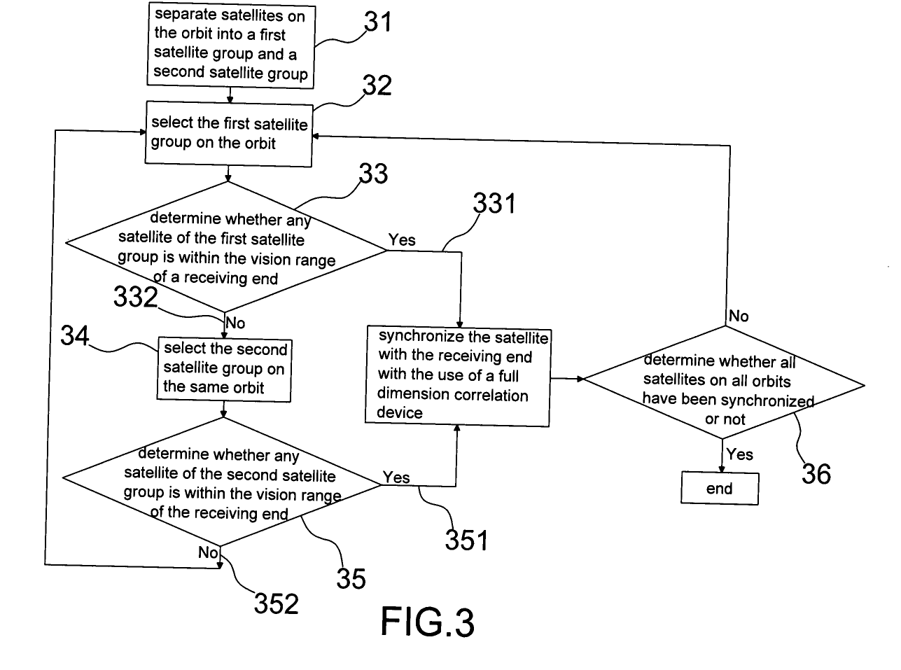

Please refer to FIG. 3 of a flow chart showing a second preferred embodiment according to the present invention. This preferred embodiment includes steps as follows:

Step 31: separate satellites on the orbit into a first satellite group and a second satellite group;

Step 32: select the first satellite group on the orbit;

Step 33: determine whether any satellite of the first satellite group is within the vision range of a receiving end with the use of a low dimension correlation device;

Step 331: synchronize the satellite with the receiving end with the use of a full dimension correlation device while the first satellite group is within the vision range of the receiving end;

Step 332: when no satellite of the first satellite group is within the vision range of the receiving end enter to step 34;

Step 34: select the second satellite group on the same orbit on which the first satellite group lies;

Step 35: determine whether any satellite of the second satellite group is within the vision range of the receiving end;

Step 351: synchronize the second satellite group with the receiving end with the use of the full dimension correlation device;

Step 352: when no satellite of the second satellite group is within the vision range of the receiving end go back to step 32; and

Step 36: determine whether all satellites on all orbits have been synchronized or not.

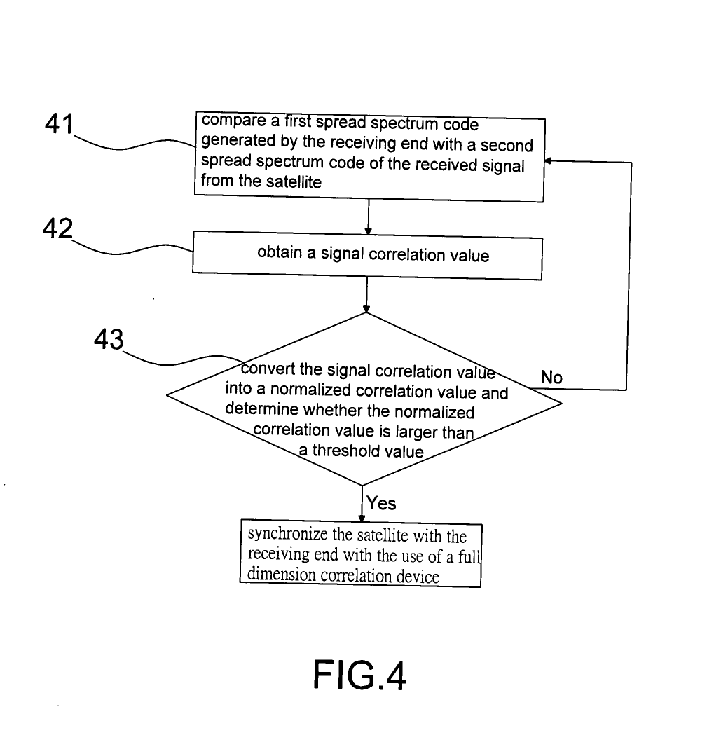

Please refer to FIG. 4 of a flow chart showing the operation of the low dimension correlation device. The present invention integrating the use of the low dimension correlation device includes steps as follows:

Step 41: compare a first spread spectrum code generated by the receiving end with a second spread spectrum code of the received signal from the satellite. The length 5 of the second spread spectrum code is between 1 to 1024 bits and such length 5 is variable so long as it is within the above range. For example, the second spread spectrum code could be 512 bits in length.

Step 42: obtain a signal correlation value;

Step 43: convert the signal correlation value into a normalized correlation value and determine whether the normalized correlation value is larger than a threshold value in the low dimension correlation device. The normalized correlation value is derived from the signal correlation value divided by a maximum signal correlation value and the threshold value is between 0.7 and 0.8.

A larger normalized correlation value (compare to the threshold value) is indicative of that the satellite is within the vision range of the receiving end; on the other end, the satellite is not within the vision range of the receiving end while the normalized correlation value is less than the threshold value.

As mentioned earlier, at the time the satellite is within the vision range of the receiving end a full dimension correlation device is employed to synchronize the satellite and the receiving end. In the case that the satellite is not within the vision range of the receiving end the low dimension correlation device is used to compare other satellites on other orbits.

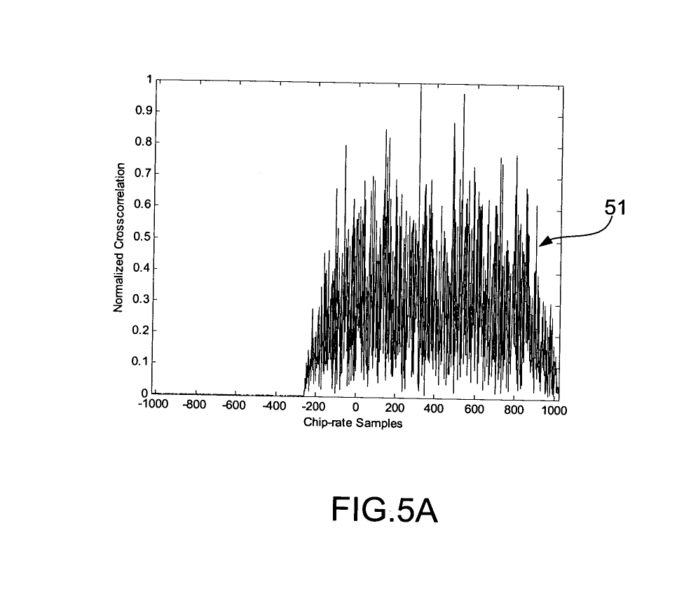

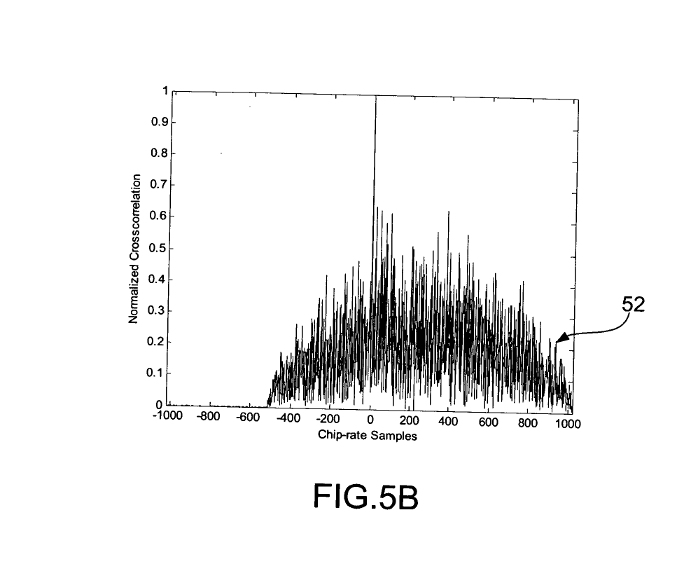

Please refer to FIGS. 5A and 5B of schematic diagrams showing the relationship between the normalized correlation value and the chip-rate sample. While the signal-to-noise (SNR) is minus 20 db, the low dimension correlation device compares spread spectrum codes in length of 256 and 512 bits, respectively, to obtain a first side band 51 and a second side band 52. The shorter the length of the spread spectrum code in terms of the number of bits is, the more significant the variation of the side band will be. In other words, the length of the compared data affects the variation of the normalized correlation value. When the length of the compared data is shorter, the probabilities of the satellite data loss/miss and false alarm of receiving from unwanted data source increase.

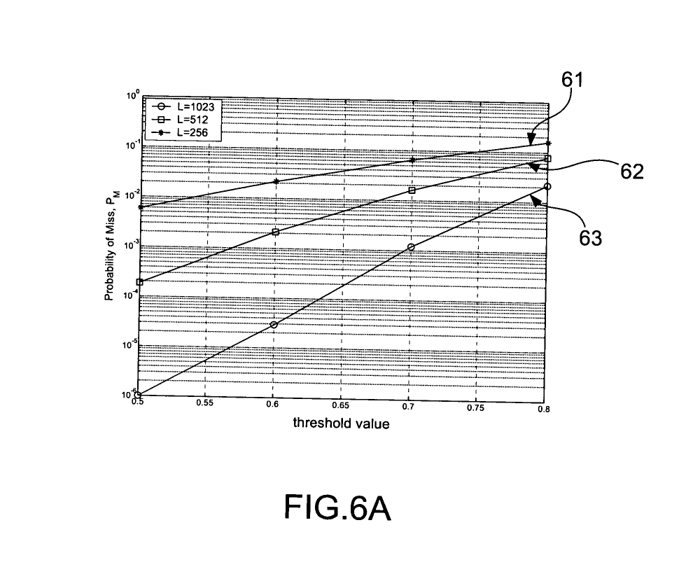

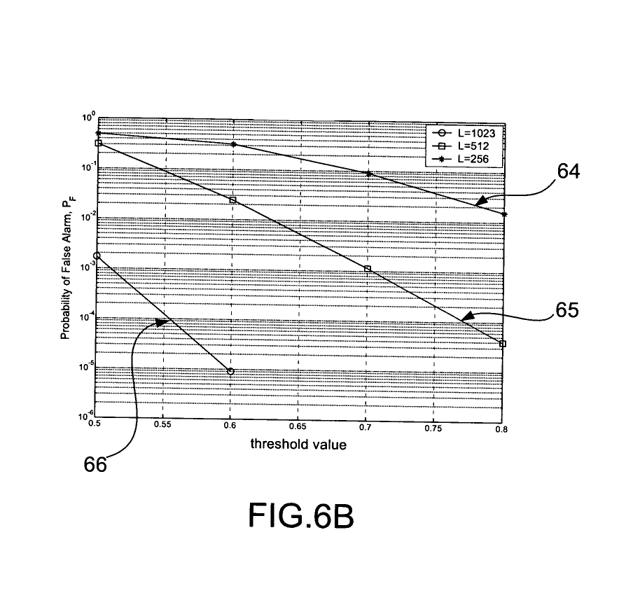

Please refer to FIGS. 6A and 6B of schematic diagrams showing the relationship between the threshold value set by the present invention and the probabilities of satellite data loss/miss and false alarm of receiving data from unwanted satellite, respectively. When the SNR of the input signal is minus 20 db, the first, second, and third relationship curves 61, 62, and 63 illustrate relationship between the probability of satellite data loss versus the threshold value while the lengths of spread spectrum code are 256, 512, and 1023 bits, respectively. When the spread spectrum code is 512 bits in length, the probability of data loss/miss is between 0.01 and 0.08, which is an acceptable range, with the threshold value ranging between 0.7 and 0.8. The probabilities of false alarm of receiving data from the unwanted source (satellite) versus the threshold value are shown as the fourth, fifth, and sixth curves 64, 65, and 66. When the spread spectrum code is 512 bits in length, the probability of the false alarm is between 0.00004 and 0.001, which is also an acceptable range, with the threshold value somewhere between 0.7 and 0.8. To sum up, setting the threshold value between 0.7 and 0.8 could help reduce probabilities of the satellite data loss/miss and the false alarm of receiving data from unwanted satellites and get the synchronization accomplished in a relatively quicker manner.

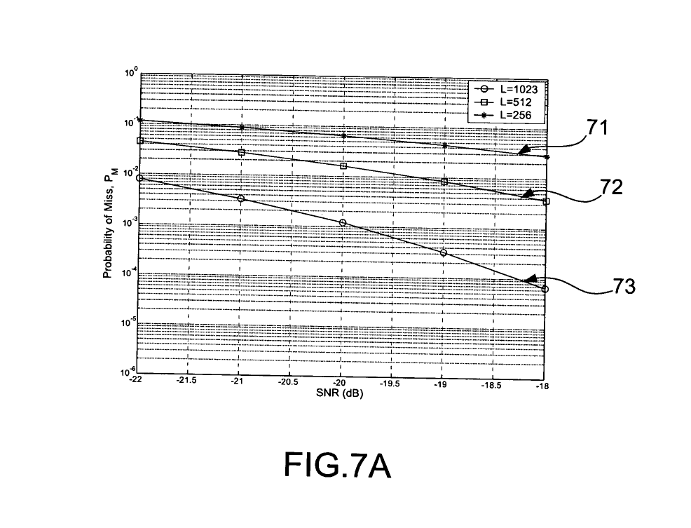

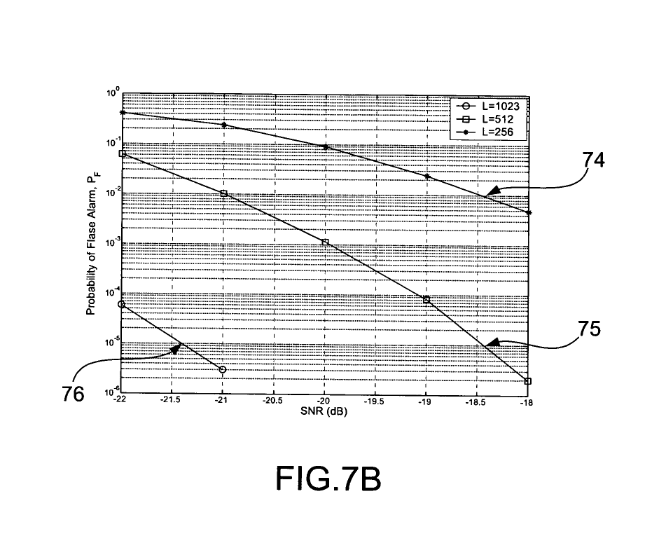

Please refer to FIGS. 7A and 7B of schematic diagrams showing relationships of the present invention SNR versus probabilities of satellite data loss/miss and the false alarm of receiving the data from unwanted satellites. Each figure illustrates three curves standing for three different spread spectrum codes of 256, 512, and 1023 bits in length, respectively. From FIG. 7A (curves 71, 72, and 73), when SNR is larger than minus 20 db the probability of satellite data loss/miss in the case of the 512-bit spread spectrum code is less than 0.01. Curves 74, 75, and 76 in FIG. 7B show that the probability of false alarm of receiving data from unwanted satellites with the 512-bit spread spectrum code is less than 0.001. Conclusively, while SNR is larger than minus 20 db the length of the spread spectrum code should be set 512 bits in order to cut down the complexity of comparison and render a quicker synchronization possible.

In contrast to the prior art, the present invention satellite tracking method first determines whether the satellite within the vision range of the receiving end with the use of low dimension correlation device, effectively reducing probabilities of satellite data loss and false alarm of receiving the data from unwanted satellites, and then synchronize the satellite with the receiving end with the use of the full dimension correlation device so as to cut down the system complexity and power consumption and achieve the goal of getting the synchronization accomplished in a relatively quicker manner.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A satellite tracking method comprising:
separating a plurality of satellites on a plurality of orbits into a first satellite group and a second satellite group;
selecting the first satellite group on the orbit;
synchronizing satellites of the first satellite group at the time the first satellite group is within the vision range of a receiving end;
selecting the second satellite group while the first satellite group is beyond the vision range of the receiving end; and
synchronizing satellites of the second satellite group while the second satellite group on the orbit is within the vision range of the receiving end.

2. The satellite tracking method in claim 1 wherein separating the satellites on the orbits into the first satellite group and the second satellite group is based on arithmetic distribution relationship between the satellites.

3. The satellite tracking method in claim 1 wherein the first satellite group includes a plurality of big-angle satellites.

4. The satellite tracking method in claim 1 wherein the second satellite group includes a plurality of satellites nearby.

5. The satellite tracking method in claim 1 wherein a first low dimension correlation device is employed to determine whether the first satellite group is within the vision range of the receiving end.

6. The satellite tracking method in claim 1 wherein a second low dimension correlation device is employed to determine whether the second satellite group is within the vision range of the receiving end.

7. The satellite tracking method in claim 1 wherein a full dimension correlation device is employed to synchronize the satellites.

8. The satellite tracking method in claim 1 further comprising a step of selecting the first satellite group on the next orbit to determine whether the selected first satellite group is within the vision range of the receiving end when the second satellite group is not within the vision range of the receiving end.

9. The satellite tracking method in claim 5 further comprising steps, for the operation of the low dimension correlation device, of comparing a first spread spectrum code generated by the receiving end and a second spread spectrum code from a received signal in order to obtain a signal correlation value, and of converting the signal correlation value into a corresponding normalized correlation value in order to determine if the normalized correlation value is larger than a threshold value.

10. The satellite tracking method in claim 9 wherein the normalized correlation value is the result of having the signal correlation value divided by a maximum signal correlation value.

11. The satellite tracking method in claim 9 wherein the larger normalized correlation value (compare to the threshold value) is indicative of the satellite is within the vision range of the receiving end.

12. The satellite tracking method in claim 9 wherein the threshold value is between 0.7 and 0.8.

13. The satellite tracking method in claim 9 wherein the length of the second spread spectrum code is between 1 and 1024 bits.

14. A satellite tracking method, comprising:
selecting a plurality of satellites on an orbit;
determining whether the satellite is within the vision range of a receiving end with the use of a low dimension correlation device; and
synchronizing the satellite if the satellite is within the vision range of the low dimension correlation device.

15. The satellite tracking method in claim 14 wherein the step of synchronizing the satellite is through the use of a full dimension correlation device.

16. The satellite tracking method in claim 14 further comprising a step of selecting a plurality of satellites on the next orbit while the all satellites on the orbit is not within the vision range of the receiving end.
